(19) United States
(12) Patent Application Publication
(10) Pub. No.: US 2003/0070337 A1
(43) Pub. Date: Apr. 17, 2003

(54) Flexible & adaptable merchandising system

(76) Inventor: Jim Music, Houston, TX (US)

Correspondence Address: Tracy S. Parris, Howrey Simon Arnold & White, LLP, 750 Bering Drive, Houston, TX, 77057-2198, US

(21) Appl. No.: 09/978,857

(22) Filed: Oct. 16, 2001

(51) Int. Cl. G09F 7/02

(52) U.S. Cl. 40/618

(57) ABSTRACT

A flexible and adaptable merchandising system. In one embodiment, the invention comprises an adaptable merchandising system for displaying merchandising inserts comprising: (a) a merchandising board having a track for retaining an adjustable channel; and (b) an adjustable channel having a wing comprising a flexible gripper for securing a merchandising insert and a flexible hinge for adapting the flexible gripper. In another embodiment the invention comprises an adaptable merchandising board for displaying merchandising inserts comprising: (a) a merchandising board having a first side and a second side; and (b) a channel having a wing comprising a gripper for gripping merchandising inserts and a flexible hinge for adapting the gripper to inserts. In another embodiment the invention comprises a merchandising channel comprising: (a) a gripper for retaining a merchandising insert; and (b) a flexible hinge for adapting the gripper to inserts.

### FIELD OF THE INVENTION

This invention relates generally to merchandising systems and more particularly, to interchangeable merchandising boards.

### BACKGROUND OF THE INVENTION

Prior art interchangeable sign board systems generally comprise rigid plastic boards having fixed rigid plastic slots molded to accept a certain style of insert, e.g., accordion style, spiral style, singular thin or thick style inserts. Generally, prior art signboards do not adapt to different shapes and thicknesses of different types of inserts. In view of large investments retailers make in signage, i.e., boards and inserts, adaptability is a very important concern for both signage manufacturers and purchasers.

Some attempts have been made in the prior art to introduce adaptability into signboards. The fixed rigid plastic used in most of these attempts fails to provide adequate movement, resulting in very little improvement, if any, in adapting to different styles of inserts.

Another problem associated with rigid plastic slots for retaining inserts is the amount of time it takes retailers to replace inserts. Inserts generally need to be slid out one end of a slot. Though some insert styles are flexible, the retention lip on many slots requires excessive bending of inserts and/or retention lips during removal, thereby damaging the inserts and/or the slots.

Yet another problem with hard plastic channel boards is a size limitation. Because most hard plastic boards do not grip inserts, larger inserts tend to sag, bow, or otherwise distort from their intended shape and direction. This problem is exacerbated by indoor and outdoor air currents. Hard plastic boards intended to grip inserts most often result in too much or too little gripping force. As previously mentioned, the limited range of motion of hard plastic makes it unsuitable for adapting to a range of insert styles. Scratching is another problem introduced by hard plastic intended to grip inserts.

One apparent attempt to ease insert replacement is the “Gotcha Flapper” merchandising strip product by Rose Displays. This product appears to be designed to grip inserts at one end. However, the design of this product fails to provide an adequate amount of movement to accept numerous styles of inserts and further is prone to breakage due to a very thin co-extrusion of two densities of vinyl. A coextrusion of hard plastic and less hard but still hard plastic is generally not an optimal solution for a hinge function because the force, i.e. resilience, of the clamping function deteriorates too rapidly to deliver a useful life. A very thin co-extrusion is even worse for longevity and functionality. Further still, gripping an insert at one end fails to address the problem of air currents.

There is a need for a merchandising board that is both flexible and adaptable to a wide range of inserts for both indoor and outdoor use. The present invention is directed to overcoming, or at least reducing the effects of, one or more of the problems set forth above.

### SUMMARY OF THE INVENTION

A flexible and adaptable merchandising system. In one embodiment, the invention comprises an adaptable merchandising system for displaying merchandising inserts comprising: (a) a merchandising board having a track for retaining an adjustable channel; and (b) an adjustable channel having a wing comprising a flexible gripper for securing a merchandising insert and a flexible hinge for adapting the flexible gripper. In another embodiment the invention comprises an adaptable merchandising board for displaying merchandising inserts comprising: (a) a merchandising board having a first side and a second side; and (b) a channel having a wing comprising a gripper for gripping merchandising inserts and a flexible hinge for adapting the gripper to inserts. In another embodiment the invention comprises a merchandising channel comprising: (a) a gripper for retaining a merchandising insert; and (b) a flexible hinge for adapting the gripper to inserts.

### BRIEF DESCRIPTION OF THE DRAWINGS

The foregoing and other features and aspects of the present invention will be best understood with reference to the following detailed description of specific embodiments of the invention, when read in conjunction with the accompanying drawings, wherein:

FIG. 1a displays a front view of an adaptable merchandising system with merchandising inserts in accordance with the present invention;

FIG. 1b displays a side view of the merchandising system of FIG. 1a;

FIG. 2a displays an isometric view of a merchandising board having tracks for retaining adjustable channels;

FIG. 2b displays an isometric view of the merchandising board of FIG. 2a with adjustable channels configured as in FIG. 1a, but without inserts;

FIG. 3a displays a close-up side view of an embodiment of a merchandising board with adjustable channel installed;

FIG. 3b displays a close-up side view of a channel being deflected away from board for installation/removal/adjustment of a merchandising insert or adaptation to the thickness of an insert.

FIG. 4a displays a close-up side view of an alternative embodiment of a merchandising board having an adjustable channel installed;

FIG. 4b displays a close-up side view of an alternative embodiment of a merchandising board having an adjustable channel installed; and

FIG. 5 displays a side view of an alternative embodiment of a merchandising board.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF EMBODIMENTS OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers' specific goals and subgoals (e.g. compliance with mechanical and business-related constraints), which will vary from one implementation to another. Moreover, attention will necessarily be paid to proper engineering and design practices for the environment in question. It will be appreciated that such a development effort might be complex and time-consuming, but would nevertheless be a routine undertaking for those of skill in the art.

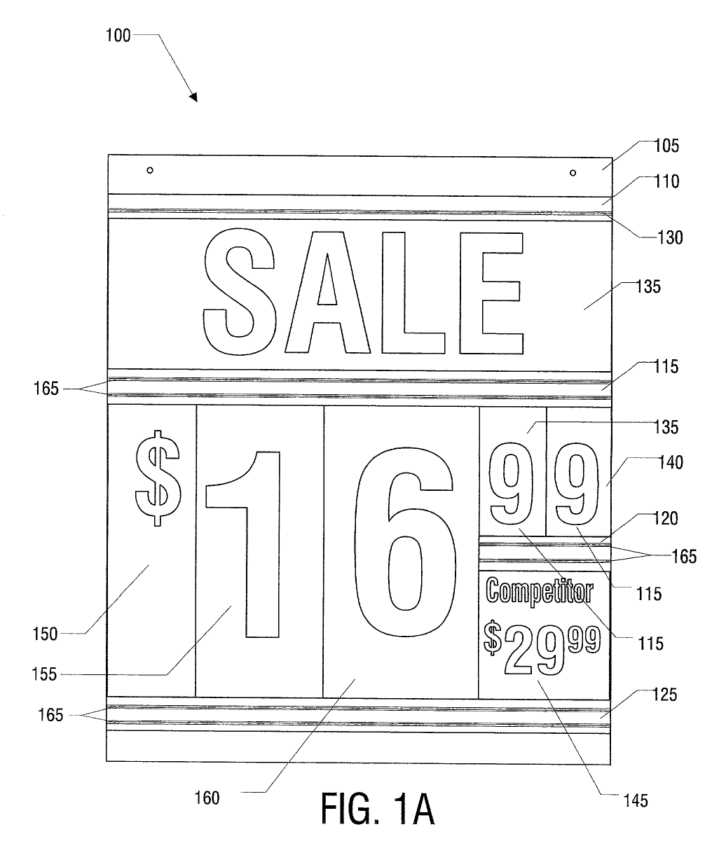

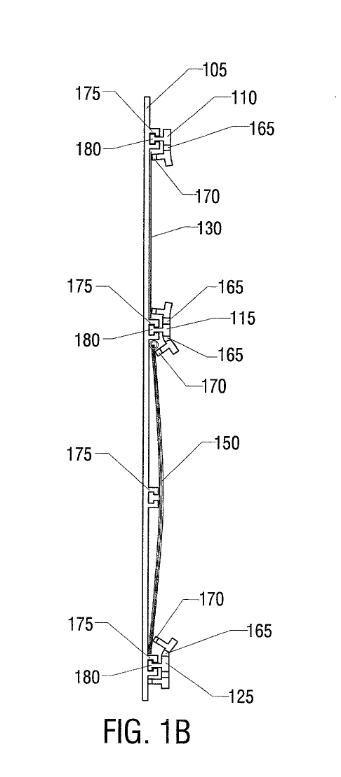

In accordance with the invention, FIG. 1a displays a front view of an adaptable merchandising system with merchandising inserts. Merchandising system 100 comprises a board 105 having a track (not visible) for retaining adjustable channels 110, 115, 120, 125 having one or more flexible grippers (not visible) for retaining merchandising inserts 130, 135, 140, 145, 150, 155, 165, and one or more flexible joints (hinges) 165 for adapting the flexible grippers to different styles of inserts and for releasing the grippers while inserting and removing inserts. In greater detail, channel 110 secures the top of insert 130 while channel 115 secures the bottom of insert 130. Channel 130 also serves to secure the top of inserts 135, 140, 150, 155, and 160. Channel 120 secures the bottom of inserts 135 and 140 and the top of insert 145. Finally, channel 125 secures the bottom portion of inserts 145, 150, 155, and 160.

It should be noted that the terms channel and track when used jointly describe mating members. Both track and channel, i.e., mating members, may be male, female, fixed, adjustable, or any combination thereof. Where a channel is referred to without specific mention of an associated track, a channel may be either, fully or partially, fixed to a board and/or associated with a mating track. The attachment mechanism, e.g. mating tracks, that which secures a channel to the board, may take infinite shape or function.

FIG. 1b displays a side view from the left side of the adaptable merchandising system of FIG. 1a. In accordance with the invention, channel 110 has one flexible gripper 170 for securing flat insert 130 by pressing the top portion of insert 130 toward board 105. Channel 115 has two grippers 170, one of which secures the lower portion of insert 130. The other gripper of channel 115 secures the top portion of spiral insert 150. Flexible hinge portion 165 allows channel 115 to adapt to the added thickness of spiral insert 150. Merchandising system 100 adapts to the length of spiral insert 150 by allowing it to flow over track 180 without the interference of channel 120. As shown in FIG. 1a, this is accomplished by cutting channel 120 to size for securing inserts 135, 140, and 145. One gripper 170 of channel 125 secures the bottom portion of spiral insert 150 while the other gripper 170 is available for securing the top portion of an insert to hang below board 105. Other terminations of board 105 are possible, including prior art slots or a track to accept an expansion board.

Also visible in the embodiment shown in FIG. 1b, channels 110, 115, and 125 are secured to board 105 by way of “C” tracks 175 on injection molded board 105 interlocking with “T” tracks 180 on each of channels 110, 115, and 125. Channels 110, 115, and 125 are positioned by sliding along the “C” track 175. Though not visible in FIG. 1b, channel 120 operates the same way. While C tracks and mating T tracks work well, there are other alternative ways to attach channels to tracks besides sliding, for instance snapping. Countless designs well within the scope of the invention include track mating shapes which would allow one side of a channel track to be inserted and then rotatably snapped into the board track. An arrow shape male and female mating track, for instance, could allow channels to be snapped into position. Similarly, male and female mating tracks may be reversed as between the board and channel. Channels 110, 115, and 125 may also be permanently affixed to board 105. Cuts (breaks) could be made in the length of the channels to adapt to varying sizes of inserts where longer inserts would flow over the channels while breaks would allow operation similar to that of removable channels.

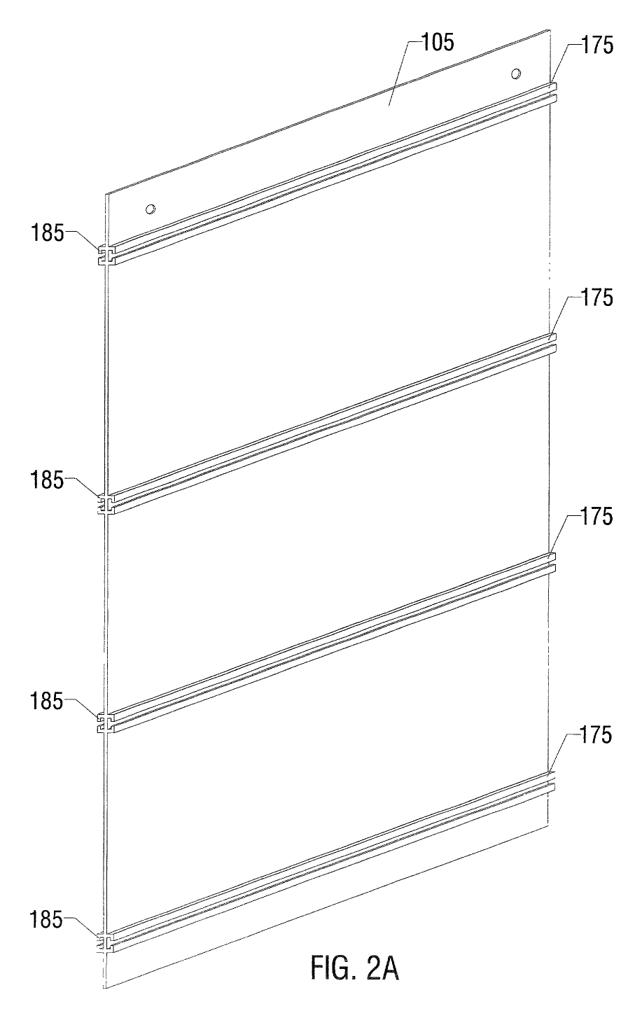

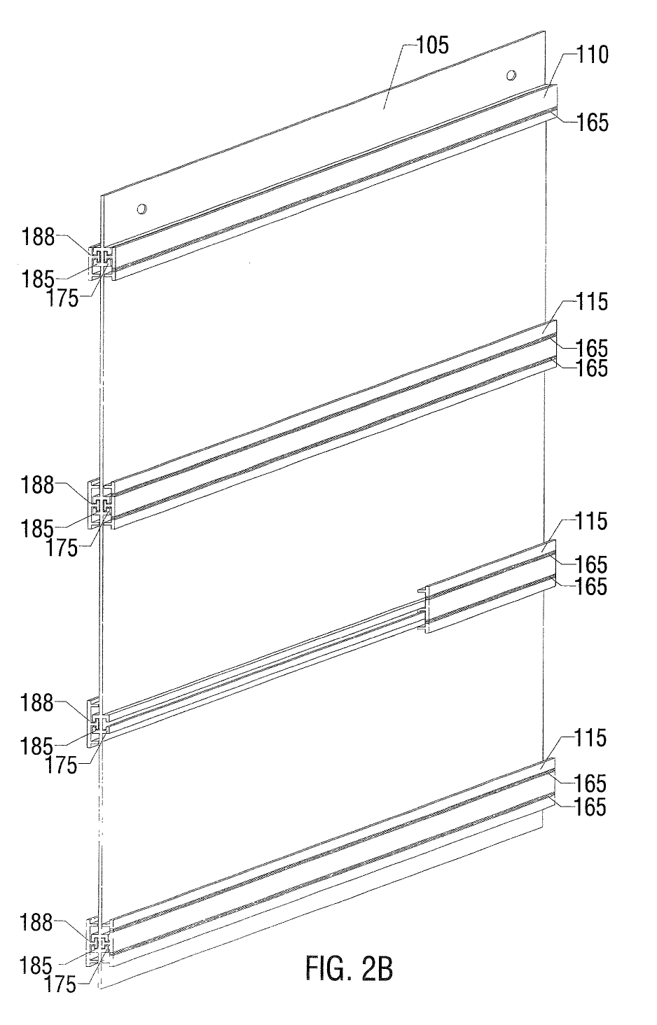

FIG. 2a displays an isometric view of merchandising board 105 without inserts or channels. Board 105 has a plurality of tracks 175 for retaining adjustable channels. FIG. 2a displays a dual-sided board with tracks 185, where inserts and channels may be installed on both sides of board 105.

FIG. 2b shows an isometric view of merchandising board 105 of FIG. 2a with adjustable channels 110, 115, 120, and 125, without inserts. FIG. 2b displays the board of FIG. 2a with channels 110, 115, 120, and 125 positioned as they are in FIG. 1a. Also shown are reverse side channels 188, inserted in tracks 185. FIG. 2b also displays flexible hinges 165 on each of channels 110, 115, 120, and 125.

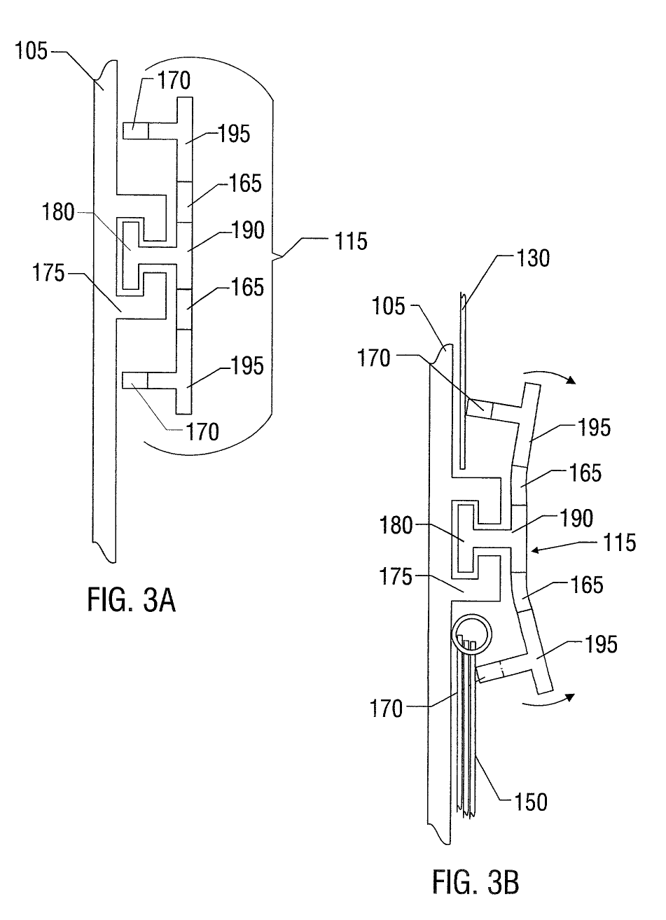

FIG. 3a shows a close-up side view of merchandising board 105 and adjustable channel 115 without inserts. Board 105 comprises a series of tracks 175 for accepting and retaining adjustable channels, e.g. 115. Channel 115 comprises body portion 190 and wing portions 195. In FIG. 3a, body portion 190 includes track 180 (e.g. “T” track), for mating to track 175 (e.g. “C” track). Wing portions 195 further comprise grippers 170. Flexible hinge 165 joins body 190 and wing 195 so that grippers 170 may adjust to various types of inserts and be deflected while installing channel 115 onto board 105 or installing/removing inserts from board 105 at channel 115.

Board 105, including tracks 175, may be formed, for example, by extruding rigid plastic material, e.g., styrene. Channel 115 may be formed, for example, by co-extruding rigid and supple plastic, or other elastomer. Body 190 and wings 195 of channel 115 may be formed, for example, of rigid plastic, e.g., styrene. Grippers 170 and hinges 165 may be formed, for example, of a more supple plastic, e.g., Kraton, or other elastomer. While gripper 170 need not be a material different from wing material 195, supple plastic offers benefits of better gripping and less scratching of inserts, as compared to rigid material. Rigid plastic material for wing 195 offers the benefit of control of the direction of force applied to inserts. Supple plastic material for flexible hinge 165 in combination with rigid plastic body 190 and rigid plastic wing 195 allows for controlled flexibility of grippers 170. Supple plastic hinge 165 also provides a much longer useful life than would a hinge formed by other means, e.g., a kinked rigid plastic or a co-extrusion of two fairly rigid plastic materials.

FIG. 3b shows a side view of channel being deflected, e.g., for installation or removal of an insert or positioning channel 115 on track 175. Pinching wings 195 together may assist in adjustment of the position of channel 115. Similarly, deflecting wings 195 assists in the installation, removal and repositioning of inserts 130, 150. Hinges 165 allow grippers 170 to adapt to varying thicknesses of inserts, e.g., the difference in thickness between flat insert 130 and spiral bound insert 150. Grippers 170 may comprise one gripper or a plurality of grippers, and may comprise any shape.

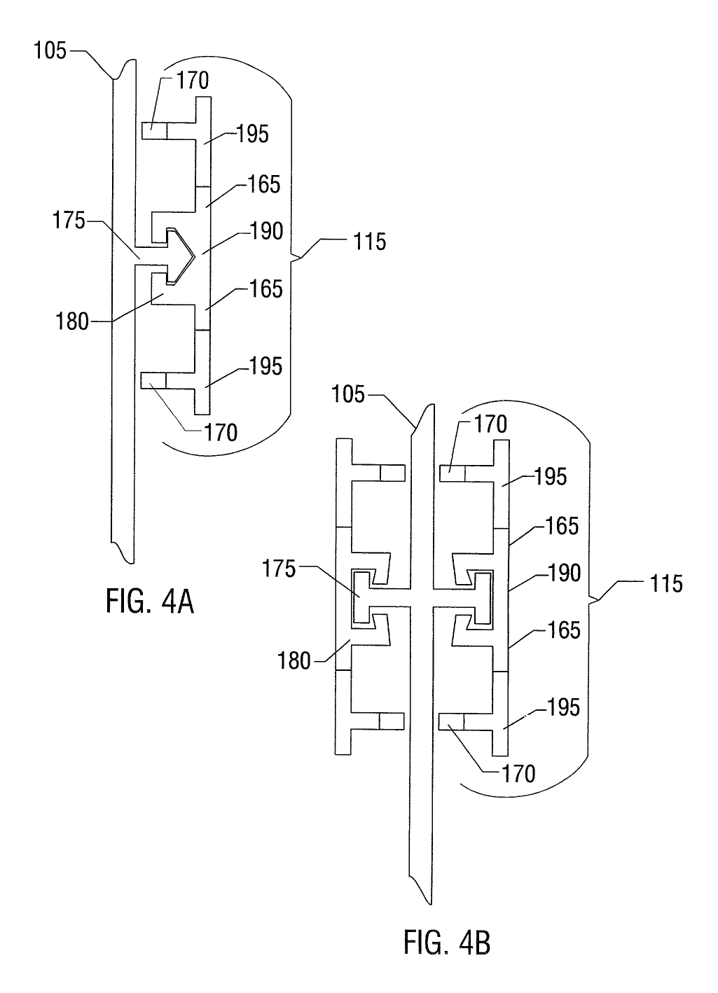

FIG. 4a displays a close-up side view of an alternative embodiment of a merchandising board having an adjustable channel installed. FIG. 4a displays male track 175 with associated mating member, e.g., female track 180 on channel 115, in the form of an arrow-shape instead of a T-shape.

FIG. 4b displays a close-up side view of an alternative embodiment of a merchandising board having an adjustable channel installed. FIG. 4b displays a variation on the T shape mating members, whereby a clamping function can be introduced by inwardly projecting female track 180.

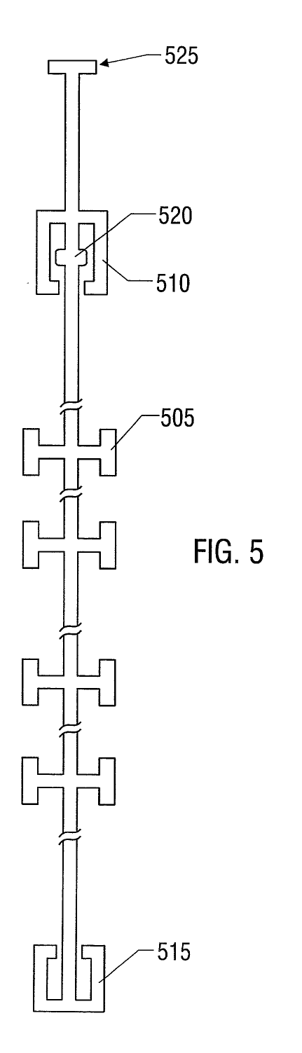

FIG. 5 displays a side view of an alternative embodiment of a merchandising board 500. Board 500 deploys a series of tracks 505, terminating the presentation area with retention channels 510 and 515. Retention channels 510 and 515 may be formed of rigid materials or they may be formed of a combination of rigid and pliable materials, e.g., like adjustable channels discussed in this application. Retention ridge 520 may be added to prevent slippage. Again, retention ridge 520 may be formed of rigid material, pliable material, or a combination thereof. Board 500 may include a support channel 525 for mating board 500 to a track system.

The merchandising system invention provides numerous benefits. It is adaptable in several ways, allowing unlimited insert configurations by selective use of tracks and channels and allowing the use of any style of insert in any position. Moreover, merchandising systems in accordance with the invention are quickly and easily interchangeable. Supple plastic grippers tend to prevent scratching of inserts and provide better gripping relative to hard plastic grippers.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. For instance, merchandising boards may be single or double sided. Tracks may run in any direction, e.g., horizontal, vertical, diagonal, mixed. Merchandising boards may be frameless or framed. Channels may take numerous natural shapes, e.g. flat, bowed. Incidentally, bowed shapes may deliver greater gripping force than flat shapes and grippers may simply be the edges of the bowed channel. Grippers on each channel may comprise one gripper or a plurality of grippers. Grippers may take any shape, e.g., rectangular, tapered, circular. Channels may be fixed to the merchandising board or removable. Channels may have one or more flexible hinges and one or more grippers. Grippers may be any material, including elastomers and rigid plastic. Accordingly, the protection sought herein is as set forth in the claims below.

What is claimed is:

1. An adaptable merchandising system for displaying at least one merchandising insert comprising:
(a) a merchandising board having a track for retaining an adjustable channel; and
(b) an adjustable channel having a wing portion comprising
(i) a flexible gripper for securing the merchandising insert and
(ii) a flexible hinge for adapting the flexible gripper.

2. The adaptable merchandising system of claim 1, wherein the merchandising board has a first side, a second side and a plurality of tracks, there being at least one track on the first side and at least one track on the second side.

3. The adaptable merchandising system of claim 1, wherein the adjustable channel has two wing portions.

4. The adaptable merchandising system of claim 1, wherein the adjustable channel is a co-extrusion of rigid plastic and elastomer, the elastomer forming the flexible gripper and the flexible hinge.

5. An adaptable merchandising system for displaying at least one merchandising insert comprising:
(a) a merchandising board having a first side, a second side, and a track on the first side for retaining an adjustable channel; and
(b) an adjustable channel having a gripper for securing the merchandising insert and a flexible hinge for adapting the gripper.

6. The adaptable merchandising system of claim 5, wherein the merchandising board has a plurality of tracks, there being at least one track on the first side and at least one track on the second side.

7. The adaptable merchandising system of claim 5, wherein the adjustable channel has two wings.

8. The adaptable merchandising system of claim 5, wherein the gripper comprises a flexible gripper.

9. The adaptable merchandising system of claim 8, wherein the adjustable channel further comprises a co-extrusion of rigid plastic and elastomer, the elastomer forming the flexible gripper and the flexible hinge.

10. An adaptable merchandising board having a channel, the channel comprising:
(a) a body;
(b) a flexible hinge; and
(c) a wing having a gripper for gripping at least one merchandising insert,
wherein the flexible hinge joins the body and the wing and the flexible hinge enables the gripper to adapt.

11. The adaptable merchandising board of claim 10, wherein the wing is segmented for adapting to merchandising insert configurations.

12. The adaptable merchandising board of claim 10, wherein the channel has two wings.

13. The adaptable merchandising system of claim 10, wherein the gripper comprises a flexible gripper.

14. The adaptable merchandising system of claim 13, wherein the channel is a co-extrusion of rigid plastic and elastomer, the elastomer forming the flexible gripper and the flexible hinge.

15. A merchandising channel comprising:
(a) a gripper for retaining a merchandising insert; and
(b) a flexible hinge for adapting the gripper to inserts.

16. The merchandising channel of claim 15, further comprising:
(c) a track for mating to a merchandising board having a mating track.

17. The merchandising channel of claim 15, wherein the gripper comprises a flexible gripper.

18. The adaptable merchandising system of claim 17, wherein the channel further comprises a co-extrusion of rigid plastic and elastomer, the elastomer forming the flexible gripper and the flexible hinge.

19. The merchandising channel of claim 16, further comprising a body and a wing, wherein the body is affixed to the track, the gripper is affixed to the wing, and the flexible hinge joins the body and wing.

20. The merchandising channel of claim 19, wherein the channel has two wings.
